(19) United States
(12) Patent Application Publication
(10) Pub. No.: US 2025/0058265 A1
(43) Pub. Date: Feb. 20, 2025

(54) Fluid Misting Air Filtration System

(71) Applicant: NAFS Enterprises LLC, West Bloomfield, MI (US)

(72) Inventor: Hisham ALLAN, Grand Prairie, TX (US)

(21) Appl. No.: 18/807,201

(22) Filed: Aug. 16, 2024

Related U.S. Application Data
(60) Provisional application No. 63/519,977, filed on Aug. 16, 2023.

(51) Int. Cl. B01D 47/06

(52) U.S. Cl. CPC B01D 47/06

(57) ABSTRACT

A fluid misting air filtration system comprises a housing comprising a top wall, a bottom wall, and a pair of side walls and defining a plenum chamber, a misting system disposed inside the plenum chamber and one or more air panels disposed inside the plenum chamber. The misting system is configured to spray atomized fluid inside the plenum chamber. The bottom wall of the housing is sloped towards a drain hole where atomized fluid containing debris leaves the plenum chamber. The one or more air panels are configured to remove atomized fluid from the plenum chamber. Atomized fluid containing debris. The misting system may be provided by misting nozzles disposed within the plenum chamber. The misting system may also be provided by a plurality of misting holes in a fluid conduit. The air panels may have a curved profile and have a convex face and a concave face.

### CROSS-REFERENCE TO RELATED APPLICATIONS

This application claims the benefit of U.S. Provisional Application No. 63/519,977, filed on Aug. 16, 2023. The entire disclosure of the above application is incorporated herein by reference.

### FIELD

The present disclosure relates to an air filtration system using a fluid mist.

### BACKGROUND

This section provides background information related to the present disclosure which is not necessarily prior art.

Air filtration systems used in systems such as HVAC systems is typically provided by disposable air filters. Dirt, debris, and allergens get caught in these disposable filters, which then become clogged. This clogging of the air filter makes the HVAC system less efficient, or even inoperable. Therefore, disposable air filters must be periodically changed in order to ensure the efficiency and operability of the system. This periodic changing of the air filter is considered by many to be a hassle that users would prefer to avoid. Many users forget to change their filters, leading to increased energy bills and possibly expensive repairs. Further, the disposable air filters must be discarded, and present an environmental cost as these disposable air filters pile up in landfills. It is therefore desirable to provide an air filtration system that does not require inconvenient and environmentally destructive disposable air filters.

### SUMMARY

This section provides a general summary of the disclosure, and is not a comprehensive disclosure of its full scope or all of its features.

To address the issues raised above, a fluid misting air filtration system is disclosed. A housing is provided which defines a plenum chamber. One or more misting nozzles may be disposed inside the plenum chamber. Fluid flows through a fluid conduit connecting a fluid source, such as a home's water system, to the misting nozzles. The misting nozzles then spray atomized fluid inside the misting chamber. A water shut off valve may be provided along the fluid conduit in order to allow the user to shut off the system. A water filter may also be provided to filter out contaminants from the fluid which may clog the system. Fluid misting may also be provided by misting holes defined by the fluid conduit. Atomized fluid sprays from the misting holes and enters the plenum chamber.

The atomized fluid inside the plenum chamber absorbs debris such as pollen and dirt. The atomized fluid then falls to the bottom wall of the housing. The bottom wall is sloped towards a drain hole where atomized fluid containing the debris exits the plenum chamber. From the drain hole, the atomized fluid may flow into the home's wastewater system, a collection tank, or to another means of disposing of the debris-containing fluid.

A plurality of air panels may be provided inside the plenum chamber which provide further removal of the atomized fluid containing the debris. When in operation, the atomized fluid containing the debris coalesce on the air panels where it falls via gravity to the bottom wall of the housing and to the drain. The air panels may have a curved profile extending from a convex face to a concave face. Air panels closer to the air outlet end may have the convex end facing the air intake end. Atomized fluid containing the debris is thereby trapped by the convex face, allowing more fluid to coalesce on the air panel.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a perspective view, partially cut away, illustrating the fluid misting air filtration system when it is in not in operation; and

FIG. 2 is a perspective view, partially cut away, illustrating the fluid misting air filtration system when it is in operation.

Corresponding reference numerals indicate corresponding parts throughout the several views of the drawings.

### DETAILED DESCRIPTION

Example embodiments will now be described more fully with reference to the accompanying drawings.

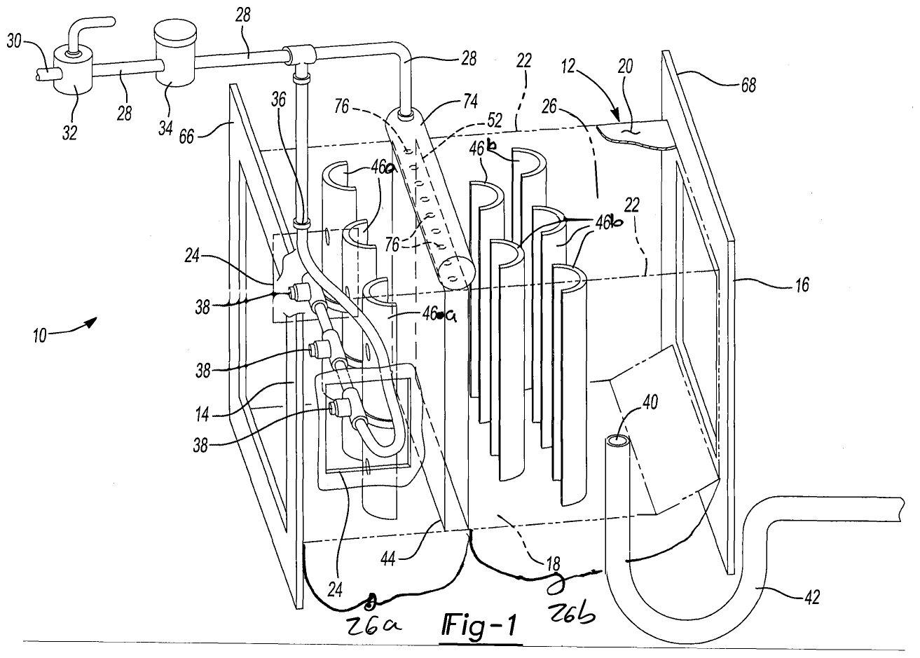

With reference to FIG. 1, the fluid misting air filtration system 10 includes a housing 12 extending from an air intake end 14 to an air outlet end 16. The housing 12 defines a plenum chamber 26. The plenum chamber may be divided into at least one misting zone 26a and a water separating zone 26b.

The housing 12 extends from an air intake end 14 to an air outlet end 16. The housing 12 extends from a bottom wall 18 to a top wall 20 and between a pair of side walls 22. A plurality of air intake openings 24 may be defined by the housing 12. For instance, one air intake opening 24 may be on one side wall 22 and may connect to a venting system, and another air intake opening 24 may be on the opposite side wall 22 and may connect to a furnace. The housing 12 defines a plenum chamber 26 enclosed by the bottom wall 18, top wall 20, and side walls 22. An air intake flange 66 may be attached to the air intake end, and an air outlet flange 68 may be attached to the air outlet end 16.

With further reference to FIG. 1, a plenum chamber misting system 28 is provided comprising a fluid conduit 30 connected to a water shut-off valve 32 configured to intake water from sources such as a home's existing plumbing system, and allowing the user to shut off and turn on the plenum chamber misting system 28. The fluid conduit may be provided with a variety of commonly known piping materials, such as PEX tubing. The water shut-off valve 32 may be any suitable commercially available water shut-off valve. From the water shut-off valve 32, the fluid flow path can continue to a water filter 34. The water filter 34 can be any commercially available water filter configured to remove impurities such as calcium which may clog or otherwise damage the plenum chamber misting system 28. From the water filter 34 the fluid conduit continues through a water inlet hole 36 defined by the housing 12, and into the plenum chamber 26. The fluid conduit 30 may connect to a plurality of misting nozzles 38 located inside the plenum chamber 26 in the misting zone 26a. The misting nozzles 38 may be any commercially available misting nozzles as are known in the art.

With further reference to FIG. 1, the fluid misting air filtration system 10 may include a top misting system 74, wherein a fluid conduit 30 runs from the water filter 34 to the top wall 20 of the housing 12. The fluid conduit 30 defines a plurality of misting holes 76 configured to spray an atomized fluid into the misting zone 26a.

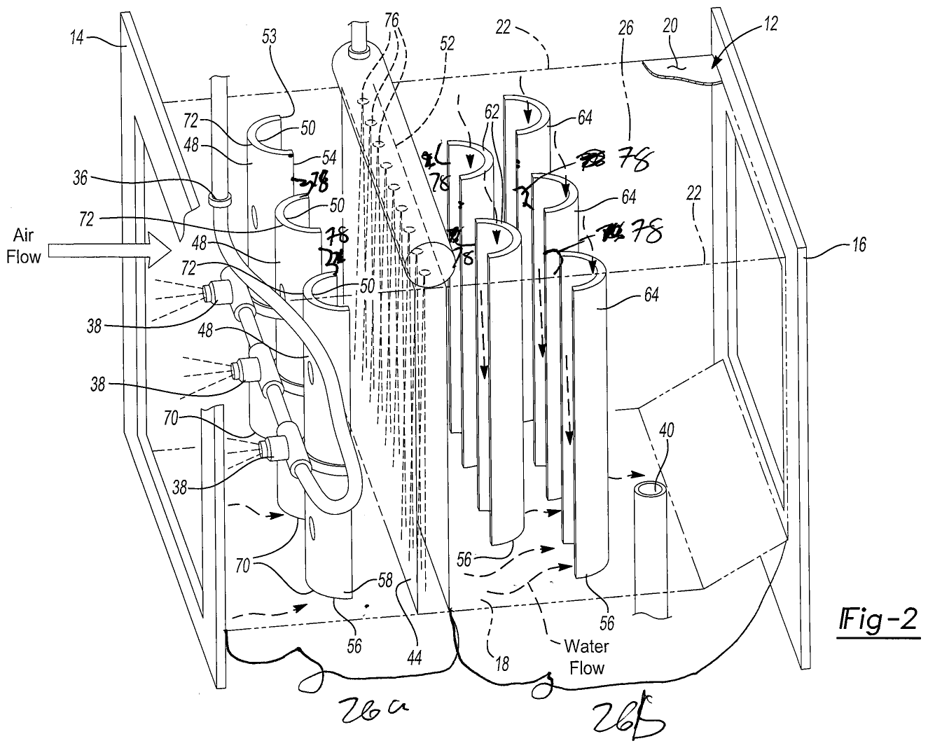

With reference to FIG. 2, the plenum chamber misting system 28 is configured to spray atomized fluid inside the plenum chamber 26 in the misting zone 26a. The fluid may spray from the misting nozzles 38. The fluid may exit the fluid conduit 30 through the misting holes 76 in the form of atomized fluid. The atomized fluid can also spray into the plenum chamber 26 through a slot, such as a microchannel slot 52, defined by the top wall 20 of the housing 12. The atomized fluid captures debris, such as dust particles, dander, and pollen, for example. The atomized fluid containing the debris then falls via gravity to the bottom wall 18 of the housing 12, where the fluid droplets containing the debris coalesce into a fluid containing the debris. The bottom wall 18 is configured to slope towards a water drainage hole 40 extending from the bottom wall 18 of the housing 12. Via gravity, the fluid containing the debris follows the slope of the bottom wall 18 and enters the water drainage hole 40. The water drainage hole 40 may lead to a p-trap 42. The p-trap 42 can include a variety of commercially available p-traps, including those used for plumbing fixtures such as sinks, bathtubs, and toilets, for example. From the p-trap 42, the fluid containing the debris flows outside the fluid misting air filtration system 10, where it may flow to a drainage tank, a waste water pipe, or may be otherwise disposed of.

With reference to FIG. 1, the top wall 20 of the housing 12 may define a microchannel slot 52. A microchannel 44 may be inserted into the microchannel slot 52 and into the plenum chamber 26, where it extends from the top wall 20 of the housing 12 to the bottom wall 18 of the housing 12. The microchannel 44 may be one of a variety of commercially available microchannels, such as an aluminum net. The microchannel 44 is configured to capture large debris such as feathers and hair, keeping such large debris out of the water drainage hole 40 to prevent clogging.

With further reference to FIG. 1, one or more upstream air panels 46a may be disposed inside the plenum chamber 26 in the misting zone 26a. The upstream air panels 46a may be composed of many different types of materials including fiberglass or plastic. The misting nozzles 38 may be attached a plurality of upstream air panels 46a in the misting zone 26a which may be located between the air intake end 14 and the microchannel 44. The attachment of the misting nozzles 38 to the upstream air panels 46a may be done with commonly known attachment methods, including but not limited to the use of zip ties, glue, or bolts. One or more downstream air panels 46b may be disposed within the plenum chamber 26 in the water separating zone 26b, which may be located between the microchannel 44 and the air outlet end 16.

With reference to FIG. 2, the upstream air panels 46a and downstream air panels 46b may extend from a bottom air panel end 70 attached to the bottom wall 18 of the housing 12, and a top air panel end 72 attached to the to the top wall 20 of the housing 12. The upstream air panels 46a and downstream air panels 46b may have a curved profile when viewed from the top air panel end 72 and bottom air panel end 70, extending from a convex face 48 to a concave face 50, and from a first air panel side 53 to a second air panel side 54. The upstream air panels 46a may be installed such that the convex face 48 faces the air intake end 14. The downstream air panels 46b may be installed such that the convex face 48 faces the air outlet end 16.

With further reference to FIG. 2, the upstream air panels 46a and downstream air panels 46b may be installed in one or more rows 56. For instance, the upstream air panels 46a may be installed in a first row 58, and the downstream air panels 46b may be installed in a second row 62, and a third row 64. One or more lateral spaces 78 may be defined by the space between upstream air panels 46a or downstream air panels 46b in the same row 56, or between an upstream air panel 46a or downstream air panel 46b and a side wall 22. Upstream air panels 46a and downstream air panels 46b may be installed such that they correspond to the lateral spaces 78 in the row 56 immediately preceding the row 56 it is installed in. For instance, downstream air panels 46b in the second row 62 may correspond to the lateral spaces 78 in the first row 58, and downstream air panels 46b in the third row 64 may correspond to the lateral spaces 78 in the second row 62.

With reference to FIG. 2, when the fluid misting air filtration system 10 is in operation, air flows from the air intake end 14 to the air outlet end 16. Atomized fluid from the plenum chamber misting system 28 enters the air flow from the plenum chamber misting system 28 in the misting zone 26a. The atomized fluid in the air may then absorb debris. The convex faces 48 of the upstream air panels 46a may direct air towards the concave faces 50 of the downstream air panels 46b in the water separation zone 26b. Air may then be held by the concave faces 50 of the downstream air panels 46b. The atomized fluid containing the debris may then coalesce on the concave faces 50 of the downstream air panels 46b. Air then flows through the lateral spaces 78 and may then be held by the concave faces 50 of the downstream air panels 46b in the proceeding row, allowing additional atomized fluid containing debris to coalesce on the concave faces 50 of the downstream air panels 46b. The downstream air panels 46b thereby reduce the amount of atomized fluid and debris in the air at the air outlet end 16.

On the concave faces 50 of the downstream air panels 46b, the atomized fluid containing debris coalesces into fluid droplets. The fluid droplets then, via gravity, fall to the bottom wall 18 of the housing 12. From the bottom wall 18, the fluid droplets flow into the water drainage hole 40 and may then flow into the p-trap 42, .the fluid may then flow to a drainage tank, a waste water pipe, or may be otherwise disposed of.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed:

1. A filtration system comprising:
a housing extending from an air intake end to an air outlet end;
the housing defining a plenum chamber;
the plenum chamber comprising a misting zone and a water separation zone;
a fluid conduit disposed within the misting zone of the plenum chamber;
one or more misting nozzles provided along the fluid conduit;
a plurality of upstream air panels disposed within the misting zone, the upstream air panels extending from a concave face to a convex face, the concave face facing the air intake end and the convex face facing the air outlet end; and
a plurality of downstream air panels disposed within the water separation zone, the downstream air panels extending from a concave face to a convex face, the concave face facing the air outlet end and the convex face facing the air intake end.
